(19) United States
(12) Patent Application Publication
(10) Pub. No.: US 2025/0337203 A1
(43) Pub. Date: Oct. 30, 2025

(54) COAXIAL CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasunori ASANO, Mie (JP); Yutaka KOBAYASHI, Mie (JP)

(21) Appl. No.: 18/871,480

(22) PCT Filed: May 16, 2023
(86) PCT No.: PCT/JP2023/018283

§ 371 Date: Dec. 4, 2024

(30) Foreign Application Priority Data
Jun. 6, 2022 (JP) 2022-091346

(51) Int. Cl. H01R 24/40; H01R 103/00

(52) U.S. Cl. CPC H01R 24/40; H01R 2103/00

(57) ABSTRACT

A coaxial connector includes an inner conductor, an insulator surrounding the inner conductor, and a tubular outer conductor surrounding the insulator. The inner conductor is in the form of a bar having a first end and a second end. The inner conductor includes a first press-fit portion located near the first end and a second press-fit portion located near the second end in an extension direction of the inner conductor. The first and second press-fit portions are located equidistant from a center in the extension direction of the inner conductor. The insulator includes an insertion hole, into which the inner conductor is inserted. The inner conductor is held in the insulator by press-fitting one of the first and second press-fit portions into the insertion hole with the first and second ends coming out from the insulator.

### TECHNICAL FIELD

The present disclosure relates to a coaxial connector.

### BACKGROUND

Patent Document 1 discloses a coaxial connector provided with an outer conductor, a center conductor and an insulating member for supporting the center conductor in the outer conductor in an insulated state. It is disclosed in Patent Document 1 that the center conductor is formed with a flange-like locking portion for locking the center conductor to the insulating member.

### PRIOR ART DOCUMENT

### Patent Document

Patent Document 1: JP 2018-026238 A

### SUMMARY OF THE INVENTION

### Problems to be Solved

According to a technique disclosed in Patent Document 1, an end part of the center conductor on one side formed with the flange-like locking portion is inserted into the insulating member. If an end part of the center conductor on the other side is inserted into the insulating member, the center conductor is erroneously assembled.

It is required to suppress the center conductor from being erroneously assembled with the insulating member.

Accordingly, the present disclosure aims to suppress an erroneous assembly of an inner conductor with an insulator.

### Means to Solve the Problem

The present disclosure is directed to a coaxial connector with an inner conductor, an insulator surrounding the inner conductor, and a tubular outer conductor surrounding the insulator, the inner conductor being in the form of a bar having a first end and a second end, the inner conductor including a first press-fit portion located near the first end and a second press-fit portion located near the second end in an extension direction of the inner conductor, the first and second press-fit portions being located equidistant from a center in the extension direction of the inner conductor, the insulator including an insertion hole, the inner conductor being inserted into the insertion hole, and the inner conductor being held in the insulator by press-fitting one of the first and second press-fit portions into the insertion hole with the first and second ends coming out from the insulator.

### Effect of the Invention

According to the present disclosure, it is possible to suppress an erroneous assembly of an inner conductor with an insulator.

### BRIEF DESCRIPTION OF THE DRAWINGS

FIG. 1 is a perspective view showing a device provided with a coaxial connector according to an embodiment.

FIG. 2 is a section along II-II of FIG. 1.

FIG. 3 is a perspective view showing the coaxial connector.

FIG. 4 is a back view showing the coaxial connector.

FIG. 5 is an exploded perspective view showing the coaxial connector.

FIG. 6 is a section along VI-VI of FIG. 3.

### DETAILED DESCRIPTION TO EXECUTE THE INVENTION

### Description of Embodiments of Present Disclosure

First, embodiments of the present disclosure are listed and described.

The coaxial connector of the present disclosure is as follows.
(1) The coaxial connector of the present disclosure is provided with an inner conductor, an insulator surrounding the inner conductor, and a tubular outer conductor surrounding the insulator, the inner conductor being in the form of a bar having a first end and a second end, the inner conductor including a first press-fit portion located near the first end and a second press-fit portion located near the second end in an extension direction of the inner conductor, the first and second press-fit portions being located equidistant from a center in the extension direction of the inner conductor, the insulator including an insertion hole, the inner conductor being inserted into the insertion hole, and the inner conductor being held in the insulator by press-fitting one of the first and second press-fit portions into the insertion hole with the first and second ends coming out from the insulator.

According to this coaxial connector, regardless of which of the first and second press-fit portions is press-fit into the insertion hole, the inner conductor is inserted into the insertion hole and held by the insulator. Further, the first and second press-fit portions are located equidistant from the center in the extension direction of the inner conductor. Thus, the positions of the first and second ends with respect to the insulator with the first press-fit portion press-fit in the insertion hole and those of the first and second ends with respect to the insulator with the second press-fit portion press-fit in the insertion hole can be aligned. That is, regardless of which of the first and second press-fit portions is press-fit into the insertion hole, an assembled state of the inner conductor with the insulator can be the same. In this way, an erroneous assembly of the inner conductor with the insulator can be suppressed.
(2) In the coaxial connector of (1), a part of the inner conductor from the center in the extension direction to the first end and a part of the inner conductor from the center in the extension direction to the second end may have the same shape.

In this way, regardless of which of the first and second press-fit portions is press-fit into the insertion hole, the assembled state of the inner conductor with the insulator can be the same.
(3) In the coaxial connector of (1) or (2), the first press-fit portion may include a first press-fit protrusion having a first slope extending gradually toward an outer peripheral side from the first end side of the inner conductor toward a central side in the extension direction of the inner conductor and a first retaining surface extending toward a center of the inner conductor from an edge of the first slope on the central side in the extension direction of the inner conductor, and the second press-fit portion may include a second press-fit protrusion having a second slope extending gradually toward the outer peripheral side from the second end side of the inner conductor toward the central side in the extension direction of the inner conductor and a second retaining surface extending toward the center of the inner conductor from an edge of the second slope on the central side in the extension direction of the inner conductor.

In this case, the first or second press-fit portion can be easily inserted into the insertion hole by bringing the first or second slope into contact with an opening edge and an inner peripheral part of the insertion hole. With the first or second press-fit portion inserted in the insertion hole, the first or second retaining surface is hooked to the inner peripheral part of the insertion hole and the first or second press-fit portion hardly comes out from the insertion hole. In this way, the inner conductor is firmly held in the insulator.
(4) In the coaxial connector of (3), angles of inclination of the first and second slopes to a center axis of the inner conductor may be equal, and the first and second retaining surfaces may be facing each other and angles of inclination thereof to the center axis of the inner conductor may be equal.

In this way, the assembled state of the inner conductor with the insulator can be the same also in a state where the first and second press-fit portions are formed into the same shape and either one of the first and second press-fit portions is press-fit in the insertion hole.
(5) In the coaxial connector of (3) or (4), the outer conductor may include a small-diameter portion, a large-diameter portion larger than the small-diameter portion and a gradually changing portion having a diameter gradually increased between the small-diameter portion and the large-diameter portion and, with one of the first and second press-fit portions press-fit in the insertion hole, the other of the first and second press-fit portions may be located to overlap the gradually changing portion in an axial direction of the outer conductor.

If the other of the first and second press-fit portions is located to overlap the gradually changing portion in the axial direction of the outer conductor in this way, a distance between the outer conductor and the inner conductor can be kept as constant as possible in the gradually changing portion. In this way, an impedance is easily adjusted in the gradually changing portion of the outer conductor.
(6) In the coaxial connector of (5), with the one of the first and second press-fit portions press-fit in the insertion hole, the other of the first and second press-fit portions may overlap 80% or more of the gradually changing portion in the axial direction of the outer conductor.

In this case, the distance between the outer conductor and the inner conductor can be kept as constant as possible in most part of the gradually changing portion in a direction along the center axis. In this way, the impedance is easily adjusted in the gradually changing portion of the outer conductor.
(7) In the coaxial connector of (5) or (6), gradients of the first and second slopes to a center axis of the inner conductor may be within +5° from a gradient of the gradually changing portion to a center axis of the outer conductor. In this way, the distance between the outer conductor and the inner conductor can be kept more constant in the gradually changing portion.
(8) In the coaxial connector of any one of (3) to (7), each of the first and second slopes may include a part arcuate about a center axis of the outer conductor.

In this case, the distance between the outer conductor and the inner conductor can be kept more constant in a circumferential direction centered on the center axis of the outer conductor. In this way, the impedance is easily adjusted.
(9) In the coaxial connector of any one of (3) to (8), the first press-fit portion may include a plurality of the first press-fit protrusions, the second press-fit portion may include a plurality of second press-fit protrusions, the plurality of first press-fit protrusions may be located at intervals around a center axis of the inner conductor in the first press-fit portion, and the plurality of second press-fit protrusions may be located at intervals around the center axis of the inner conductor in the second press-fit portion.

In this case, the first or second press-fit portion is more easily press-fit as compared to the case where a protrusion for press-fitting projects over the entire periphery of the press-fit portion.
(10) In the coaxial connector of (9), the plurality of first press-fit protrusions may be located at equal intervals around the center axis of the inner conductor in the first press-fit portion, and the plurality of second press-fit protrusions may be located at equal intervals around the center axis of the inner conductor in the second press-fit portion. In this case, rotational symmetry is easily given to physical properties influential to the impedance around the inner conductor. In this way, the impedance is stabilized around the inner conductor.

### Details of Embodiment of Present Disclosure

A specific example of a coaxial connector of the present disclosure is described with reference to the drawings. Note that the present disclosure is not limited to these illustrations, but is represented by claims and intended to include all changes in the scope of claims and in the meaning and scope of equivalents.

### Embodiment

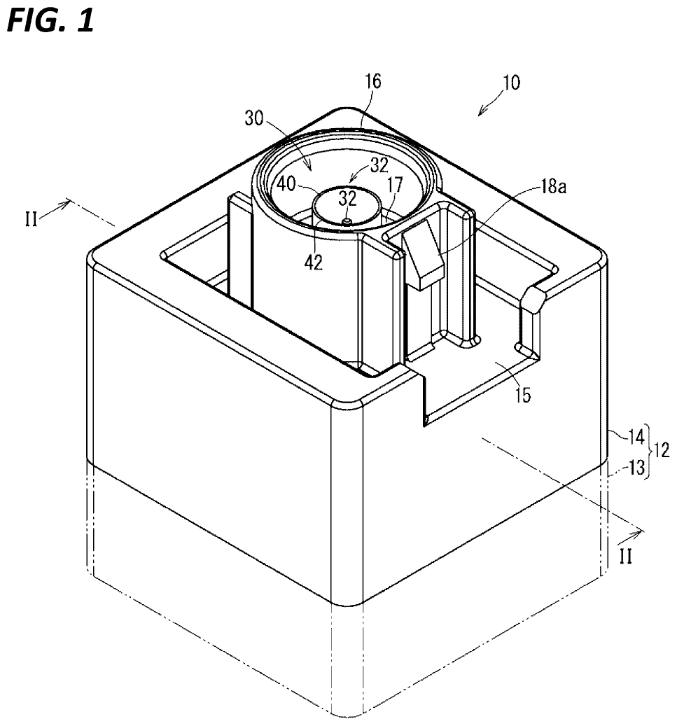

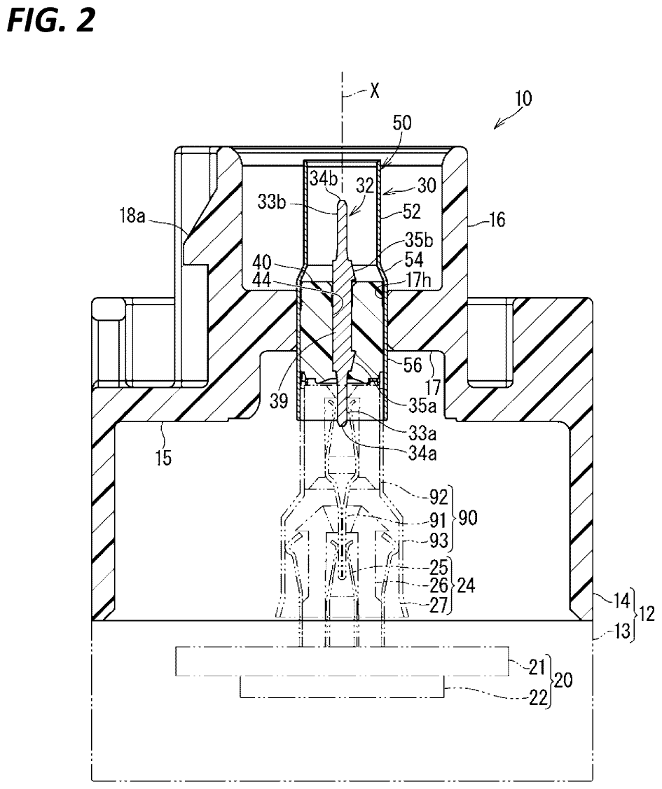

Hereinafter, a coaxial connector according to an embodiment is described. FIG. 1 is a perspective view showing a device 10 provided with a coaxial connector 30. FIG. 2 is a section along II-II of FIG. 1.

### <Concerning Overall Configuration of Device>

The device 10 is, for example, a camera device. The camera device is, for example, an in-vehicle device. The device 10 may not be a camera device.

The device 10 is provided with a case 12, an electrical component 20 and the coaxial connector 30. The electrical component 20 is accommodated in the case 12. The coaxial connector 30 is a coaxial connector for connecting the electrical component 20 and an external electrical component. For example, the coaxial connector 30 is a coaxial connector, to which a cable connected to the external electrical component is connected. The cable connected to the coaxial connector 30 is, for example, a coaxial cable.

The case 12 is provided with a first case 13 and a second case 14. The first and second cases 13, 14 are, for example, made of resin. By uniting the first and second cases 13, 14, the case 12 in the form of a rectangular parallelepiped box for accommodating the electrical component 20 is configured. If the device 10 is a camera device, it is assumed that the first case 13 includes a lens or window for imaging and the second case 14 includes the coaxial connector 30.

The electrical component 20 is, for example, a mounting board, in which electronic components are mounted on a board. If the device 10 is a camera device, the electrical component 20 is assumed to include a circuit board 21 and an imaging element 22 mounted on the circuit board 21. The imaging element 22 faces the lens or window for imaging of the first case 13 and images an outside view by turning the lens or window. The side of the first case 13, toward which the imaging element 22 is facing, may be referred to as a front side, and the side of the second case 14 opposite to the front side may be referred to as a rear side.

In this embodiment, the electrical component 20 is provided with a board-side connector 24 located on a surface of the circuit board 21 opposite to the imaging element 22. The board-side connector 24 is, for example, provided with a board-side inner conductor 25, a board-side insulator 26 and a board-side outer conductor 27. The board-side inner conductor 25 is surrounded by the board-side insulator 26. A dielectric can be grasped as one type of insulator, and the board-side insulator 26 may be a dielectric. The board-side insulator 26 is surrounded by the board-side outer conductor 27. The board-side connector 24 projects from the circuit board 21 toward the coaxial connector 30.

A relay connector 90 is connected to the board-side connector 24. The relay connector 90 is, for example, provided with a movable-side inner conductor 91, a movable-side insulator 92 and a movable-side outer conductor 93. The movable-side inner conductor 91 is surrounded by the movable-side insulator 92. A dielectric can be grasped as one type of insulator, and the movable-side insulator 92 may be a dielectric. The movable-side insulator 92 is surrounded by the movable-side outer conductor 93. With the movable-side inner conductor 91 inserted and connected to the board-side inner conductor 25 and the board-side outer conductor 27 inserted and connected to the movable-side outer conductor 93, the relay connector 90 is connected to the board-side connector 24. The relay connector 90 projects further toward the coaxial connector 30 from the board-side connector 24. The relay connector 90 relays and connects the board-side connector 24 and the coaxial connector 30. The relay connector 90 is posture-changeably connected to the board-side connector 24 and the coaxial connector 30.

The coaxial connector 30 is provided on the side of the second case 14, i.e. on a rear side of the case 12. More specifically, a holding tube portion 16 projects on a bottom portion 15 of the case 12. The holding tube portion 16 is a hollow cylinder and projects outward from a central part of the bottom portion 15. An inner opening of the holding tube portion 16 is open to the inside of the second case 14, and an outer opening of the holding tube portion 16 is open to the outside of the second case 14. A holding/partitioning portion 17 is formed in an axially intermediate part of the holding tube portion 16. In this embodiment, the holding/partitioning portion 17 is formed at a position near the inner opening in the axially intermediate part of the holding tube portion 16. The holding/partitioning portion 17 partitions between a space on the side of the inner opening and a space on the side of the outer opening in the holding tube portion 16. The holding/partitioning portion 17 is formed with a holding hole 17h, and the coaxial connector 30 is inserted and held in this holding hole 17h. The holding/partitioning portion 17 may be continuous and flush with the inner surface of the bottom part 15.

In this embodiment, a locking protrusion 18a for holding a cable connector mounted on an end part of a cable is formed on an outer peripheral part of the holding tube portion 16. It is not essential that the locking protrusion 18a is formed.

The relay connector 90 is connected to the coaxial connector 30 in the case 12. By connecting a cable from outside to the coaxial connector 30, an external electrical component as a connection destination of this cable and the electrical component 20 in the case 12 are electrically connected.

### <Coaxial Connector>

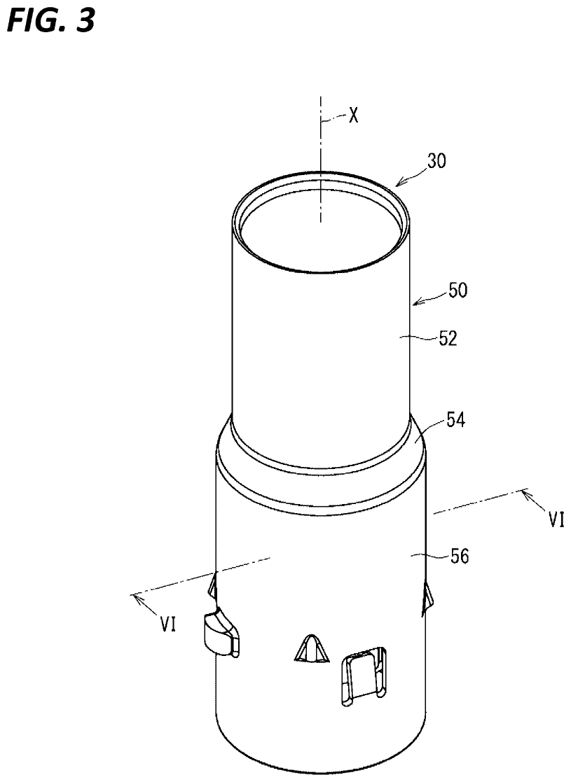

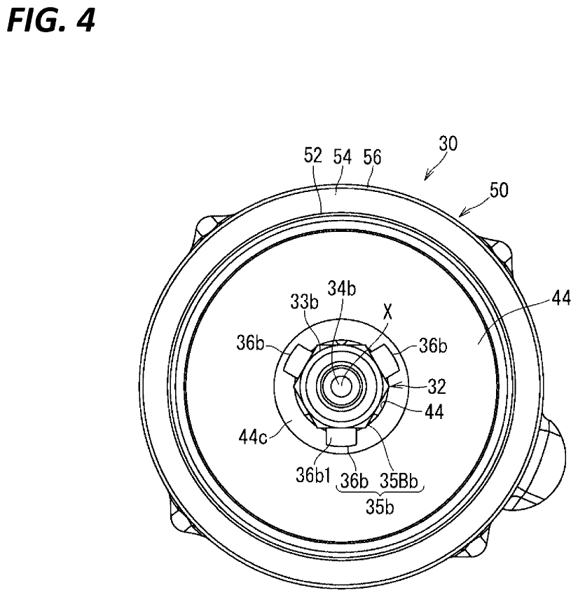

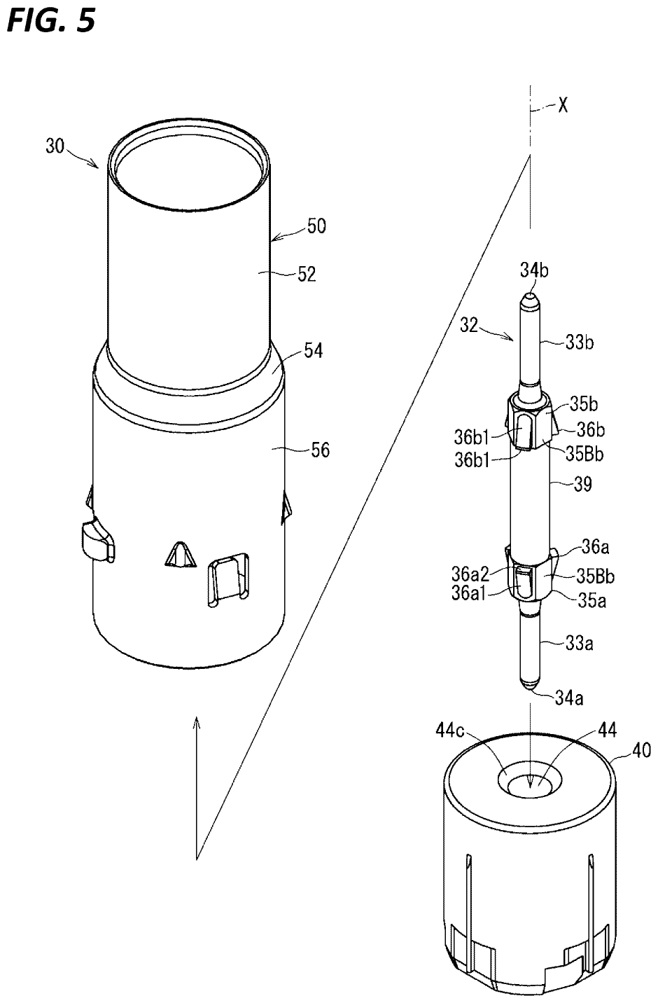

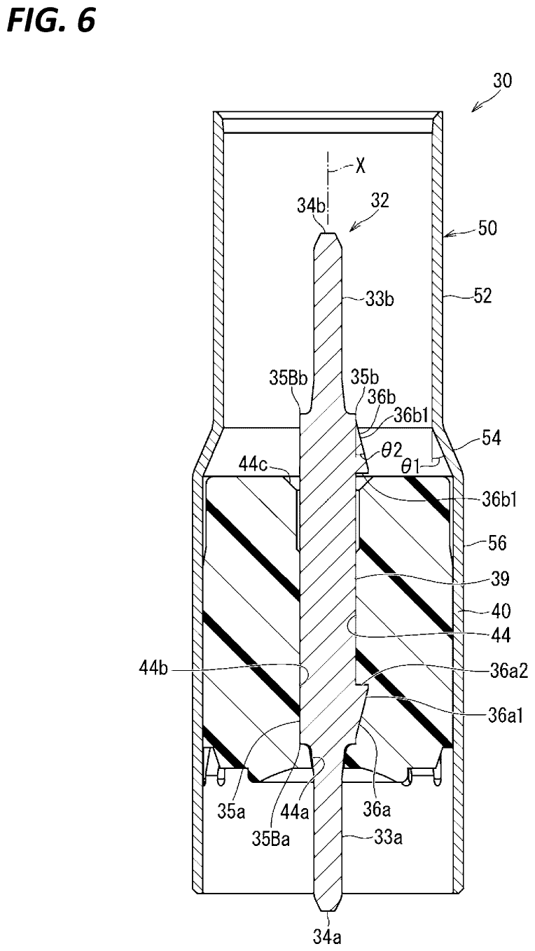

The coaxial connector 30 is more specifically described. FIG. 3 is a perspective view showing the coaxial connector 30. FIG. 4 is a back view showing the coaxial connector 30. FIG. 5 is an exploded perspective view showing the coaxial connector 30. FIG. 6 is a section along VI-VI of FIG. 3.

As shown in FIGS. 1 to 6, the coaxial connector 30 is provided with an inner conductor 32, an insulator 40 and an outer conductor 50.

The inner conductor 32 is in the form of an elongated bar and made of an electrically conductive material such as metal. The insulator 40 is made of an insulating material such as resin and surrounds the inner conductor 32. In this embodiment, the insulator 40 is a dielectric. The outer conductor 50 is made of an electrically conductive material such as metal. The outer conductor 50 is formed into a tubular shape surrounding the insulator 40. More specifically, the outer conductor 50 is formed into a hollow cylindrical shape. A center axis X of the inner conductor 32, a center axis X of the insulator 40 and a center axis X of the outer conductor 50 are located at the same position.

The configuration of each component is more specifically described.

The inner conductor 32 is in the form of a bar including a first end 34a and a second end 34b. The first end 34a is facing the inside of the case 12, and the second end 34b is facing the outside of the case 12. In this embodiment, the inner conductor 32 is in the form of a straight bar, but may be in the form of an L-shaped bar.

In this embodiment, the inner conductor 32 includes an intermediate trunk portion 39, a first connecting end part 33a and a second connecting end part 33b.

The intermediate trunk portion 39 is in the form of a round bar except at a first press-fit portion 35a and a second press-fit portion 35b. The intermediate trunk portion 39 is mainly a part to be embedded in the insulator 40 and held by the insulator 40. The first and second connecting end parts 33a, 33b are in the form of round bars. The first connecting end part 33a is a part used for connection to the relay connector 90 in the case 12, and the second connecting end part 33b is a part used for connection to the cable outside the case 12.

The first connecting end part 33a extends from one end of the intermediate trunk portion 39, and the second connecting end part 33b extends from the other end of the intermediate trunk portion 39. An outer end of the first connecting end part 33a is the first end 34a, and an outer end of the second connecting end part 33b is the second end 34b. Although the first and second ends 34a, 34b are rounded, this is not essential. The first and second connecting end parts 33a, 33b have the same length and the same thickness. That is, the first and second connecting end parts 33a, 33b have the same shape. In this embodiment, the inner conductor 32 is in the form of a straight bar, but may be in the form of an L-shaped bar.

The intermediate trunk portion 39 is thicker than the first and second connecting end parts 33a, 33b. Thus, annular steps corresponding to this thickness difference are located between the intermediate trunk portion 39 and the first connecting end part 33a and between the intermediate trunk portion 39 and the second connecting end part 33b. It is not essential that the intermediate trunk portion 39 is thicker than the first and second connecting end parts 33a, 33b, and the intermediate trunk portion, the first connecting end part and the second connecting end part may have the same thickness.

The inner conductor 32 includes the first and second press-fit portions 35a, 35b. The first and second press-fit portions 35a, 35b are parts to be pushed into the insulator 40 under pressure. In an extension direction of the inner conductor 32, the first press-fit portion 35a is located near the first end 34a by being closer to the first end 34a than to the second end 34b, and the second press-fit portion 35b is located on the second end 34b by being closer to the first end 34a and the second end 34b.

The first and second press-fit portions 35a, 35b are located equidistant from a center in the extension direction of the inner conductor 32. In other words, a distance of the first press-fit portion 35a to the first end 34a and a distance of the second press-fit portion 35b to the second end 34b are equal. Note that equidistant or equal distance means equal within an error range (e.g. equal within a range of +1 mm).

In this embodiment, the first press-fit portion 35a is located on an end part of the intermediate trunk portion 39 on the side of the first end 34a, and the second press-fit portion 35b is located on an end part of the intermediate trunk portion 39 on the side of the second end 34b. If base end parts of the first and second connecting end parts 33a, 33b are press-fit into the insulator 40, the first and second press-fit portions may be formed on the first and second connecting end parts 33a, 33b.

The first press-fit portion 35a includes a first press-fit body portion 35Ba and first press-fit protrusions 36a.

The press-fit body portion 35Ba is formed into a regular polygonal shape, here a regular hexagonal shape. The first press-fit body portion may have a cylindrical shape, e.g. may be a round bar-like part continuous from an intermediate part of the intermediate trunk portion 39.

The first press-fit protrusions 36a project from the outer peripheral part of the first press-fit body portion 35Ba. The first press-fit protrusion 36a has a first slope 36a1 and a first retaining surface 36a2.

The first slope 36al extends gradually toward an outer peripheral side from the side of the first end 34a of the inner conductor 32 toward a central side in the extension direction of the inner conductor 32. Thus, the first press-fit protrusion 36a is formed into a shape having a projecting height gradually increased from the side of the first end 34a of the inner conductor 32 toward the central side in the extension direction of the inner conductor 32 in the first press-fit body portion 35Ba.

In this embodiment, the first slope 36al has an arcuate shape centered on the center axis X of the outer conductor 50 (see FIG. 4). That is, if the first press-fit protrusion 36a of the inner conductor 32 is cut by a plane orthogonal to the center axis X of the inner conductor 32, the first slope 36al is observed as an arcuate shape centered on the center axis X of the outer conductor 50. It is not essential that the first slope 36a has the arcuate shape. The first slope may be a flat surface.

The first retaining surface 36a2 extends toward a center of the inner conductor 32 from an edge of the first slope 36a on a central side in the extension direction of the inner conductor 32. For example, the first retaining surface 36a2 may be a surface orthogonal to the center axis X of the inner conductor 32. Thus, a part of the first press-fit protrusion 36a on the central side in the extension direction of the inner conductor 32 has the first retaining surface 36a2 extending toward the central side in the extension direction of the inner conductor 32.

In this embodiment, the first press-fit portion 35a includes a plurality of the first press-fit protrusions 36a. In the first press-fit portion 35a, the plurality of first press-fit protrusions 36a are located at intervals around the center axis X of the inner conductor 32. Here, the plurality of first press-fit protrusions 36a are located at equal intervals around the center axis X of the inner conductor 32. When viewed along the center axis X, the plurality of first press-fit protrusions 36a are formed to radially project around the center axis X. More specifically, the first press-fit body portion 35Ba has a hexagonal shape and the first press-fit protrusions 36a are provided on every other one of six side surfaces. Thus, the first press-fit portion 35a includes three press-fit protrusions 36a provided at intervals of 120° around the center axis X of the inner conductor 32.

Note that the number of the first press-fit protrusions 36a is arbitrary. For example, the first press-fit portion may include one press-fit protrusion. In this case, the one first press-fit protrusion may be an annular protrusion provided on the first press-fit portion entirely in a circumferential direction or a protrusion provided in a circumferential part of the first press-fit portion. Further, the plurality of press-fit protrusions may be located at unequal intervals around the center axis X of the inner conductor.

Similarly to the first press-fit portion 35a, the second press-fit portion 35b includes a second press-fit body portion 35Bb corresponding to the first press-fit body portion 35Ba and second press-fit protrusions 36b corresponding to the first press-fit protrusions 36a. Similarly to the first press-fit portion 35a, the second press-fit protrusion 36b has a second slope 36b1 corresponding to the first slope 36a1 and a second retaining surface 36b2 corresponding to the first retaining surface 36a2. Thus, angles of inclination of the first and second slopes 36a1, 36b1 to the center axis X of the inner conductor 32 are equal. Further, the first and second retaining surfaces 36a2, 36n2 are facing each other, and angles of inclination thereof to the center axis X of the inner conductor 32 are equal.

In this embodiment, a part of the inner conductor 32 from the center in the extension direction to the first end 34a and a part of the inner conductor 32 from the center in the extension direction to the second end 34b have the same shape. More specifically, the first and second connecting end parts 33a, 33b have the same shape, and the first and second press-fit portions 35a, 35b have the same shape. It is not essential that the first and second connecting end parts 33a, 33b have the same shape and the first and second press-fit portions 35a, 35b have the same shape. The first and second connecting end parts 33a, 33b may be similarly shaped to such an extent as to be connectable to the connectors inside and outside the case 12. Further, the first and second press-fit portions 35a, 35b may be similarly shaped to such an extent as to be retainable in an insertion hole 44.

Here, if a plane passing through the center in the extension direction of the inner conductor 32 and perpendicular to an axial direction of the inner conductor 32 is a plane of symmetry, one end part and the other end part of the inner conductor 32 are plane-symmetrical. It is not essential that the one end part and the other end part of the inner conductor 32 are plane-symmetrical with respect to the plane of symmetry. For example, an object shaped by rotating the one end part and the other end part of the inner conductor 32 according to this embodiment around the center axis X of the inner conductor 32 may be an inner conductor. For example, the positions of the second press-fit protrusions 36b in the second press-fit portion 35b may be shifted by 60° from those of the first press-fit protrusions 36a in the first press-fit portion 35b around the center axis X of the inner conductor 32.

The insulator 40 is, for example, a molded resin component. The insulator 40 is formed into a cylindrical shape. A length of the insulator 40 is shorter than that of the inner conductor 32. The insertion hole 44 is formed along an extension direction of the insulator 40 in a center of the insulator 40. An opening portion 44a on one end side of the insertion hole 44 is formed to have a smaller diameter than a hole body 44b in an intermediate part in the extension direction of the insertion hole 44. The opening portion 44a is so sized that the first connecting end part 33a (or the second connecting end part 33b) can be inserted, but the intermediate trunk portion 39 cannot be inserted. For example, a diameter of the opening portion 44a is set to be equal to or larger than that of the first connecting end part 33a (or the second connecting end part 33b) and smaller than that of the intermediate trunk portion 39. The hole body 44b of the insertion hole 44 is so sized that the intermediate trunk portion 39 is insertable. For example, a diameter of the hole body 44b is set to be equal to that of the intermediate trunk portion 39.

Thus, if the inner conductor 32 is inserted into the insertion hole 44 through the opening on the other end side of the insertion hole 44, the first connecting end part 33a (or the second connecting end part 33b) is inserted into the opening portion 44a through the hole body 44b and the intermediate trunk portion 39 is inserted into the hole body 44b. With the annular step between the first connecting end part 33a (or the second connecting end part 33b) and the intermediate trunk portion 39 held in contact with the opening portion 44a from inside, the inner conductor 32 is positioned in an insertion direction with respect to the insertion hole 44. This positioned state is a completed state of the coaxial connector 30.

In this state, the first connecting end part 33a including the first end 34a (or the second connecting end part 33b including the second end 34b) comes out from one end of the insulator 40. Further, the second connecting end part 33b including the second end 34b (or the first connecting end part 33a including the first end 34a) comes out from the other end of the insulator 40. Furthermore, an end part of the intermediate trunk portion 39 on the side of the second connecting end part 33b (or the first connecting end part 33a) protrudes from the other end of the insulator 40 without entering the insertion hole 44.

Note that an opening portion 44c on the other end side of the insertion hole 44 is formed into a tapered shape gradually spreading outward. An insertion end of the inner conductor 32 is guided into the insertion hole 44 by this opening portion 44c.

As described above, with the inner conductor 32 inserted in the insertion hole 44 and held by the insertion hole 40, one of the first and second press-fit portions 35a, 35b is press-fit into the insertion hole 44 and the inner conductor 32 is held in the insulator 40. Further, in this state, the other of the first and second press-fit portions 35a, 35b protrudes from the insertion hole 44. For example, it is thought to insert the inner conductor 32 into the insertion hole 44 with the first end 34a in the lead. The first press-fit protrusions 36a project further outward than the intermediate trunk portion 39. Thus, if an attempt is made to insert the inner conductor 32 into the insertion hole 44, the first press-fit protrusions 36a interfere with an inner peripheral part of the insertion hole 44. Accordingly, the inner conductor 32 is press-fit into the insertion hole 44 while the inner peripheral part of the insertion hole 44 is deformed by the first press-fit protrusions 36a. At this time, since the first slopes 36al contact the opening and the inner peripheral part of the insertion hole 44, the first press-fit protrusions 36a can smoothly move in the insertion hole 44. As described above, with the inner conductor 32 completely inserted in the insulator 40, the inner peripheral part of the insertion hole 44 tries to return to an original shape. Thus, the first retaining surfaces 36a2 of the first press-fit protrusions 36a are retained and hooked to the inner peripheral part of the insertion hole 44. In this way, the inner conductor 32 is prevented from coming out from the insertion hole 44. In this state, the second press-fit portion 35b is located outside the insulator 40, wherefore the second press-fit portion 35b hardly hinders an inserting operation of the inner conductor 32.

As described above, both end parts of the inner conductor 32 are formed into the same shape. Thus, if the inner conductor 32 is inserted into the insertion hole 44 with the second end 34b in the lead, a positional relationship of the first and second connecting end parts 33a, 33b is reversed and that of the first and second press-fit portions 35a, 35b is reversed, but an assembled component having the same shape as above can be obtained.

The outer conductor 50 is made of metal or the like. For example, the outer conductor 50 may be formed by deep drawing a metal material, may be formed by press-working a metal plate, may be formed by die molding or may be formed by cutting.

The outer conductor 50 has a hollow cylindrical shape. A length of the outer conductor 50 is larger than that of the insulator 40. The insulator 40 is located in an intermediate part in an extension direction of the outer conductor 50. The first and second connecting end parts 33a, 33b projecting in both ends of the outer conductor 50 may be located in centers in the both ends of the outer conductor 50. The first and second connecting end parts 33a, 33b may come out from the outer conductor 50.

In this embodiment, the outer conductor 50 includes a small-diameter portion 52, a large-diameter portion 56 larger than the small-diameter portion 52 and a gradually changing portion 54 having a diameter gradually increased between the small-diameter portion 52 and the large-diameter portion 56. The large-diameter portion 56 is a part facing the inside of the case 12, and the small-diameter portion 52 is a part facing the outside of the case 12. The large-diameter portion 56 has a diameter corresponding to a thickness of the relay connector 90 as a connection destination in the case 12, and the small-diameter portion 52 has a diameter corresponding to a thickness of the connector on the end part of the cable outside the case 12. The large-diameter portion 56 of the outer conductor 50 is press-fit and held in the holding hole 17h. A thickness relationship may be reversed in the both ends of the outer conductor in accordance with the thicknesses of the connectors as the connection destinations or the outer conductor 50 may have a tubular shape having a uniform diameter. The gradually changing portion 54 is formed into a tapered shape having a diameter gradually increased from the small-diameter portion 52 toward the large-diameter portion 56.

The insulator 40 is set to have such a thickness as to be insertable into the large-diameter portion 56. For example, an outer diameter of the insulator 40 is equal to an inner diameter of the large-diameter portion 56 and larger than an inner diameter of the small-diameter portion 52. The insulator 40 is press-fit into the outer conductor 50 through an opening on the side of the large-diameter portion 56. The insulator 40 is located adjacent to the gradually changing portion 54 in the large-diameter portion 56. For example, an end surface of the insulator 40 facing the small-diameter portion 52 is located on a boundary between the gradually changing portion 54 and the large-diameter portion 56.

In this way, with one of the first and second press-fit portions 35a, 35b inserted in the insertion hole 44, the other of the first and the second press-fit portions 35a, 35b is located to overlap the gradually changing portion 54 in a direction of the center axis X of the outer conductor 50. Note that the insulator 40 may be located away from the gradually changing portion 54, and the other of the first and second press-fit portions 35a, 35b may overlap the gradually changing portion 54 at a position distant from the insulator 40.

Here, that the other of the first and second press-fit portions 35a, 35b overlaps the gradually changing portion 54 in the direction of the center axis X of the outer conductor 50 means not only a case where the other of the first and second press-fit portions 35a, 35b entirely overlaps the gradually changing portion 54 in the direction of the center axis X of the outer conductor 50, but also a case where the other of the first and second press-fit portions 35a, 35b at least partially overlaps at least a part of the gradually changing portion 54 in the direction of the center axis X of the outer conductor 50.

If the first press-fit protrusions 36a of the first press-fit portion 35a (or the second press-fit protrusions 36b of the second press-fit portion 35b) are located to overlap the gradually changing portion 54 in the direction of the center axis X, an impedance of the coaxial connector 30 can be easily adjusted. For example, the impedance of the coaxial connector 30 can be easily adjusted to be within a range of +10 22, preferably +5 (2 with respect to a target impedance corresponding to an impedance of a coaxial connector or the like as a connection destination.

That is, it is desired to adjust the impedance in accordance with a communication path serving as a connection destination to satisfy communication performance via the coaxial connector 30. The impedance of the coaxial connector 30 is adjusted by a distance between the inner conductor 32 and the outer conductor 50, a dielectric constant of the insulator 40 and the like. In the small-diameter portion 52, which is a part of the outer conductor 50 having a constant diameter, the distance between the inner conductor 32 and the outer conductor 50 is constant along the center axis X. Further, also in the large-diameter portion, which is a part of the outer conductor 50 having a constant diameter, the distance between the inner conductor 32 and the outer conductor 50 is constant along the center axis X. Thus, in the small-diameter portion 52 and the large-diameter portion 56, the impedance can be easily adjusted in consideration of the distance between the inner conductor 32 and the outer conductor 50. On the other hand, since the distance between the inner conductor 32 and the outer conductor 50 varies along the center axis X in the gradually changing portion 54, it is possibly difficult to adjust the impedance in consideration of the distance between the inner conductor 32 and the outer conductor 50.

Accordingly, if the first press-fit protrusions 36a of the first press-fit portion 35a (or the second press-fit protrusions 36b of the second press-fit portion 35b) overlap the gradually changing portion 54 in the direction of the center axis X, the distance between the inner conductor 32 and the outer conductor 50 can be grasped as constant or substantially constant along the center axis X in a part where the first press-fit protrusions 36a (or the second press-fit protrusions 36b) are formed. In this way, the impedance can be easily adjusted in consideration of the distance between the inner conductor 32 and the outer conductor 50, which can be grasped as constant or substantially constant.

From the above point of view, the second press-fit protrusions 36b (or the first press-fit protrusions 36a) may, for example, overlap 80% or more of the gradually changing portion 54 in the axial direction of the outer conductor 50 to make a variation of the distance between the inner conductor 32 and the outer conductor 50 as little as possible in the gradually changing portion 54.

Further, to make the variation of the distance between the inner conductor 32 and the outer conductor 50 as little as possible in a part where the second press-fit protrusions 36b (or the first press-fit protrusions 36a) are arranged, a direction of inclination of the gradually changing portion 54 to the direction along the center axis X may be the same as that of the first slopes 36al (or the second slopes 36b1). In this embodiment, the gradually changing portion 54 and the first slopes 36al (or the second slopes 36b1) arranged in the gradually changing portion 54 are gradually inclined toward the outer peripheral side from the small-diameter portion 52 toward the large-diameter portion 56. To make the variation of the distance between the inner conductor 32 and the outer conductor 50 as little as possible in the part where the second press-fit protrusions 36b (or the first press-fit protrusions 36a) are arranged, a gradient θ2 of the first slopes 36a1 (or the second slopes 36b1) to the center axis X may be within ±5° from a gradient θ1 of the gradually changing portion 54 to the center axis X.

Note that the insulator 40 may be formed with recesses or protrusions for retention or rotation prevention with respect to the outer conductor 50. Further, the outer conductor 50 may be formed with recesses or protrusions for retention or rotation prevention with respect to the insulator 40 or the holding hole 17h.

### Effects, Etc.

According to the coaxial connector 30 configured as described above, the inner conductor 32 includes the first press-fit portion 35a located near the first end 34a and the second press-fit portion 35b located near the second end 34b, and one of the first and second press-fit portions 35a, 35b is press-fit into the insertion hole 44 and the inner conductor 32 is held in the insulator 40 with the first and second ends 34a, 34b coming out from the insulator. Thus, regardless of which of the first and second press-fit portions 35a, 35b is press-fit into the insertion hole 44, the inner conductor 32 is inserted into the insertion hole 44 and held by the insulator 40. Further, the first and second press-fit portions 35a, 35b are located equidistant from the center in the extension direction of the inner conductor 32. Thus, the positions of the first and second ends 34a, 34b with respect to the insulator 40 with the first press-fit portion 35a press-fit in the insertion hole 44 and those of the first and second ends 34a, 34b with respect to the insulator 40 with the second press-fit portion 35b press-fit in the insertion hole 44 can be aligned. That is, regardless of which of the first and second press-fit portions 35a, 35b is press-fit into the insertion hole 44, the assembled state of the inner conductor 32 with the insulator 40 can be the same. In this way, an erroneous assembly of the inner conductor 32 with the insulator 40 can be suppressed.

Note that the erroneous assembly of the inner conductor with the insulator means a state where the assembled state of the inner conductor with the insulator is different from a proper assembled state in design. If the press-fit portion is provided only on either one end of the inner conductor unlike the present disclosure, an erroneous assembly in which the press-fit portion is not retained in the insulator can occur if a press-fitting direction of the inner conductor is mistaken. In the connector according to the present disclosure, if the press-fit portions are respectively provided near the both ends of the inner conductor 32, either one of the press-fit portions can be retained in the insulator and the occurrence of an erroneous assembly is suppressed regardless of which of the both ends of the inner conductor is inserted into the insulator.

Further, if the part of the inner conductor 32 from the center in the extension direction to the first end 34a and the part of the inner conductor 32 from the center in the extension direction to the second end 34b have the same shape, the assembled state of the inner conductor 32 with the insulator 40 can be the same, regardless of which of the first and second press-fit portions 35a, 35b is press-fit into the insertion hole 44. In this way, connection to the mating connectors inside and outside the case 12 can be smoothly performed.

Further, the first press-fit portion 35a includes the first press-fit protrusions 36a each having the first slope 36al and the first retaining surface 36a2, and the second press-fit portion 35b includes the second press-fit protrusions 36b each having the second slope 36b1 and the second retaining surface 36b2. Thus, the first or second press-fit portion 35a, 35b can be easily inserted into the insertion hole 44 by bringing the first or second slopes 36a1, 36b1 into contact with the opening edge and the inner peripheral part of the insertion hole 44. With the first or second press-fit portion 35a, 35b inserted in the insertion hole 44, the first or second retaining surfaces 36a2, 36b2 are hooked to the inner peripheral part of the insertion hole 44 and the first or second press-fit portion 35a, 35b hardly comes out from the insertion hole 44. In this way, the inner conductor 32 is firmly held in the insulator 40.

Further, if the angles of inclination of the first and second slopes 36a1, 36b1 are equal, the first and second retaining surfaces 36a2, 36b2 are facing each other and the angles of inclination of the first and second retaining surfaces 36a2, 36b2 are equal, the first and second press-fit portions 35a, 35b are easily formed into the same shape. In this way, regardless of which of the first and second press-fit portions 35a, 35b is press-fit into the insertion hole 44, the assembled state of the inner conductor 32 with the insulator 40 can be the same. In this way, connected states to the mating connectors inside and outside the case 12 are easily adjusted to be the same.

Further, with one of the first and second press-fit portions 35a, 35b press-fit in the insertion hole 44, the other of the first and second press-fit portions 35a, 35b is located to overlap the gradually changing portion 54 in the direction of the center axis X. Thus, the distance between the inner conductor 32 and the outer conductor 50 can be kept as constat as possible in the gradually changing portion 54. In this way, the impedance is easily adjusted in the gradually changing portion 54.

That is, the inner conductor 32 is provided with the first and second press-fit portions 35a, 35b to suppress an erroneous assembly, and one of the first and second press-fit portions 35a, 35b is used to prevent the inner conductor from coming out and the other is used for impedance adjustment. Thus, new projections may not be provided on the inner conductor only for impedance adjustment.

As a result of an easy impedance adjustment in the coaxial connector 30, impedance matching is performed and communication performance via the coaxial connector 30 is improved.

For example, if the other of the first and second press-fit portions 35a, 35b overlaps 80% or more of the gradually changing portion 54 in the direction of the center axis X, the distance between the outer conductor 50 and the inner conductor 32 can be kept as constant as possible in most part of the gradually changing portion 54. In this way, the impedance is easily adjusted in the gradually changing portion 54.

If the gradients θ2 of the first and second slopes 36a1, 36b1 are within ±5° from the gradient θ1 of the gradually changing portion 54, the distance between the outer conductor 50 and the inner conductor 32 can be kept more constant in the gradually changing portion 54.

Further, if each of the first and second slopes 36a1, 36b1 includes a part arcuate about the center axis X, the distance between the outer conductor 50 and the inner conductor 32 can be kept more constant in the gradually changing portion 54 in the circumferential direction centered on the center axis X. In this way, the impedance is easily adjusted.

Further, since the plurality of first or second press-fit protrusions 36a, 36b are located at intervals around the center axis X in each of the first and second press-fit portions 35a, 35b, press-fitting is more easily performed as compared to the case where a protrusion for press-fitting projects over the entire periphery of the press-fit portion.

Further, since the plurality of first or second press-fit protrusions 36a, 36b are located at equal intervals around the center axis X in each of the first and second press-fit portions 35a, 35b, rotational symmetry is easily given to physical properties influential to the impedance around the inner conductor 32. In this way, the impedance is stabilized around the inner conductor 32.

### Modifications

The coaxial connector 30 may be applied for the connection of an electrical component and a cable not based on the device 10.

Note that the respective configurations described in the above embodiment and the respective modifications can be appropriately combined as long as these do not contradict each other.

List of Reference Numerals

| | |
|---|---|
| 10 | device |
| 12 | case |
| 13 | first case |
| 14 | second case |
| 15 | bottom portion |
| 16 | holding tube portion |
| 17 | holding/partitioning portion |
| 17h | holding hole |
| 18a | locking protrusion |
| 20 | electrical component |
| 21 | circuit board |
| 22 | imaging element |
| 24 | board-side connector |
| 25 | board-side inner conductor |
| 26 | board-side insulator |
| 27 | board-side outer conductor |
| 30 | coaxial connector |
| 32 | inner conductor |
| 33a | first connecting end part |
| 33b | second connecting end part |
| 34a | first end |
| 34b | second end |
| 35Ba | first press-fit body portion |
| 35Bb | second press-fit body portion |
| 35a | first press-fit portion |
| 35b | second press-fit portion |
| 36a | first press-fit protrusion |
| 36a1 | first slope |
| 36a2 | first retaining surface |
| 36b | second press-fit protrusion |
| 36b1 | second slope |
| 36b2 | second retaining surface |
| 39 | intermediate trunk portion |
| 40 | insulator |
| 44 | insertion hole |
| 44a, 44c | opening portion |
| 44b | hole body |
| 50 | outer conductor |
| 52 | small-diameter portion |
| 54 | gradually changing portion |
| 56 | large-diameter portion |
| 90 | relay connector |
| 91 | movable-side inner conductor |
| 92 | movable-side insulator |
| 93 | movable-side outer conductor |
| X | center axis |
| θ1, θ2 | gradient |

1. A coaxial connector, comprising:
an inner conductor;
an insulator surrounding the inner conductor; and
a tubular outer conductor surrounding the insulator,
the inner conductor being in the form of a bar having a first end and a second end,
the inner conductor including a first press-fit portion located near the first end and a second press-fit portion located near the second end in an extension direction of the inner conductor,
the first and second press-fit portions being located equidistant from a center in the extension direction of the inner conductor,
the insulator including an insertion hole, the inner conductor being inserted into the insertion hole, and
the inner conductor being held in the insulator by press-fitting one of the first and second press-fit portions into the insertion hole with the first and second ends coming out from the insulator.

2. The coaxial connector of claim 1, wherein a part of the inner conductor from the center in the extension direction to the first end and a part of the inner conductor from the center in the extension direction to the second end have the same shape.

3. The coaxial connector of claim 1, wherein:
the first press-fit portion includes a first press-fit protrusion having a first slope extending gradually toward an outer peripheral side from the first end side of the inner conductor toward a central side in the extension direction of the inner conductor and a first retaining surface extending toward a center of the inner conductor from an edge of the first slope on the central side in the extension direction of the inner conductor, and
the second press-fit portion includes a second press-fit protrusion having a second slope extending gradually toward the outer peripheral side from the second end side of the inner conductor toward the central side in the extension direction of the inner conductor and a second retaining surface extending toward the center of the inner conductor from an edge of the second slope on the central side in the extension direction of the inner conductor.

4. The coaxial connector of claim 3, wherein:
angles of inclination of the first and second slopes to a center axis of the inner conductor are equal, and
the first and second retaining surfaces are facing each other and angles of inclination thereof to the center axis of the inner conductor are equal.

5. The coaxial connector of claim 3, wherein:
the outer conductor includes a small-diameter portion, a large-diameter portion larger than the small-diameter portion and a gradually changing portion having a diameter gradually increased between the small-diameter portion and the large-diameter portion, and
with one of the first and second press-fit portions press-fit in the insertion hole, the other of the first and second press-fit portions is located to overlap the gradually changing portion in an axial direction of the outer conductor.

6. The coaxial connector of claim 5, wherein, with the one of the first and second press-fit portions press-fit in the insertion hole, the other of the first and second press-fit portions overlaps 80% or more of the gradually changing portion in the axial direction of the outer conductor.

7. The coaxial connector of claim 5, wherein gradients of the first and second slopes to a center axis of the inner conductor are within ±5° from a gradient of the gradually changing portion to a center axis of the outer conductor.

8. The coaxial connector of claim 3, wherein each of the first and second slopes includes a part arcuate about a center axis of the outer conductor.

9. The coaxial connector of claim 3, wherein:
the first press-fit portion includes a plurality of the first press-fit protrusions,
the second press-fit portion includes a plurality of second press-fit protrusions,
the plurality of first press-fit protrusions are located at intervals around a center axis of the inner conductor in the first press-fit portion, and
the plurality of second press-fit protrusions are located at intervals around the center axis of the inner conductor in the second press-fit portion.

10. The coaxial connector of claim 9, wherein:
the plurality of first press-fit protrusions are located at equal intervals around the center axis of the inner conductor in the first press-fit portion, and
the plurality of second press-fit protrusions are located at equal intervals around the center axis of the inner conductor in the second press-fit portion.
